(19) United States
(12) Patent Application Publication
(10) Pub. No.: US 2026/0170945 A1
(43) Pub. Date: Jun. 18, 2026

(54) TRAFFIC ESTIMATION APPARATUS, UPDATE APPARATUS, TRAFFIC ESTIMATION METHOD, UPDATE METHOD, AND COMPUTER PROGRAM

(71) Applicant: SUMITOMO ELECTRIC INDUSTRIES, LTD., Osaka-shi, Osaka (JP)

(72) Inventors: Tomoyuki KITADA, Osaka-shi, Osaka (JP); Hajime SAKAKIBARA, Osaka-shi, Osaka (JP); Shigeki NISHIMURA, Osaka-shi, Osaka (JP); Tsuyoshi HAGA, Osaka-shi, Osaka (JP)

(73) Assignee: SUMITOMO ELECTRIC INDUSTRIES, LTD., Osaka-shi, Osaka (JP)

(21) Appl. No.: 19/125,290

(22) PCT Filed: Sep. 25, 2023
(86) PCT No.: PCT/JP2023/034744

§ 371 Date: Apr. 28, 2025

(30) Foreign Application Priority Data
Oct. 28, 2022 (JP) 2022-173198

(51) Int. Cl. G08G 1/01; G08G 1/0967

(52) U.S. Cl. CPC G08G 1/0104; G08G 1/0112; G08G 1/0133; G08G 1/0141; G08G 1/096741; G08G 1/09675

(57) ABSTRACT

A traffic-volume estimation device includes a communication unit that communicates with a plurality of probe vehicles; a storage unit that accumulates probe information pertaining to the plurality of probe vehicles; and a processing unit that performs traffic-volume estimation processing for obtaining an estimate for the traffic volume of vehicles on a feeder road connected to a first target location in a road network. The traffic-volume estimation processing includes: a first process for obtaining, on the basis of the probe information, movement information that includes a time, that was needed for the probe vehicle positioned at a second target location on the feeder road to pass by the first target location, and the distance from the second target location to the first target location; and a second process for obtaining the estimate by referring to a traffic-volume estimation table that is updated on the basis of satellite data.

### TECHNICAL FIELD

The present disclosure relates to a traffic estimation apparatus, an update apparatus, a traffic estimation method, an update method, and a computer program. This application claims priority from Japanese Patent Application No. 2022-173198 filed on Oct. 28, 2022, and the entire contents of the Japanese patent application are incorporated herein by reference.

### BACKGROUND ART

Patent literature 1 discloses a technique for performing signal control by obtaining a traffic index such as a load factor based on probe information.

### CITATION LIST

### Patent Literature

PATENT LITERATURE 1: WO 2020/071040

### SUMMARY OF THE INVENTION

A traffic estimation apparatus according to the present disclosure includes a communication unit configured to communicate with a plurality of probe vehicles, a storage unit configured to store probe information of the plurality of probe vehicles, and a processing unit configured to execute a traffic estimation process for obtaining an estimate of vehicle traffic on an inflow road connected to a first target point on a road network. The traffic estimation process includes a first process for obtaining movement information based on the probe information, the movement information including a time taken for a probe vehicle located at a second target point on the inflow road to pass through the first target point and a distance from the second target point to the first target point, and a second process for obtaining the estimate with reference to a traffic estimation table, the traffic estimation table being updated based on satellite data obtained by observing an area including the first target point and the inflow road. The traffic estimation table has registered therein vehicle count information indicating the number of vehicles from a position of a probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other. The second process obtains the estimate based on the vehicle count information corresponding to the movement information obtained in the first process.

### BRIEF DESCRIPTION OF THE DRAWINGS

FIG. 1 is a perspective view showing an example of the overall configuration of an information providing system.

FIG. 2 is a block diagram showing an example of the internal configuration of an information providing apparatus included in the information providing system and an in-vehicle apparatus of a probe vehicle.

FIG. 3 is a block diagram showing a part of process functions of the processing unit.

FIG. 4 is a diagram for explaining a traffic estimation process.

FIG. 5 is a flow chart showing an example of a traffic estimation process.

FIG. 6 is a diagram schematically showing the trajectory point of the probe vehicle entering the inflow road.

FIG. 7 is a diagram showing an example of a traffic estimation table.

FIG. 8 is a flowchart showing an example of the update process.

FIG. 9 is a diagram schematically showing a part of captured images of a first target point and an inflow road included in satellite data.

FIG. 10 is a schematic diagram showing a side view of a sag portion on a highway.

FIG. 11 is a block diagram showing the configuration of an information providing system according to modification.

### DETAILED DESCRIPTION

### Problems to be Solved by Present Disclosure

As in the conventional example, appropriate control can be performed by using probe information in signal control. Incidentally, it is considered that the probe information is used not only for signal control but also for management of vehicle traffic at a specific location on a road. However, the proportion of probe vehicles among all vehicles is not high, and furthermore, there are probe vehicles that do not upload probe information, present among the probe vehicles. Thus, it is considered that there are a considerable number of vehicles that do not upload probe information, present beyond the anticipated amount. Thus, it may be difficult to accurately estimate traffic at a specific location.

### Advantageous Effects of Present Disclosure

According to the present disclosure, vehicle traffic can be accurately estimated.

### Description of Embodiments of Present Disclosure

First, the contents of the embodiment will be listed and described.

### Outline of Embodiments

(1) A traffic estimation apparatus according to an embodiment includes a communication unit configured to communicate with a plurality of probe vehicles, a storage unit configured to store probe information of the plurality of probe vehicles, and a processing unit configured to execute a traffic estimation process for obtaining an estimate of vehicle traffic on an inflow road connected to a first target point on a road network. The traffic estimation process includes a first process for obtaining movement information based on the probe information, the movement information including a time taken for a probe vehicle located at a second target point on the inflow road to pass through the first target point and a distance from the second target point to the first target point, and a second process for obtaining the estimate with reference to a traffic estimation table, the traffic estimation table being updated based on satellite data obtained by observing an area including the first target point and the inflow road. The traffic estimation table has registered therein vehicle count information indicating the number of vehicles from a position of a probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other. The second process obtains the estimate based on the vehicle count information corresponding to the movement information obtained in the first process.

During the time of observation of satellite data, which is the observation result of the area including the first target point and the inflow road, when there is a probe vehicle present on the inflow road, it is possible, based on the satellite data, to detect not only the presence of the probe vehicle but also the presence of vehicles lined up on the inflow road between the position of the probe vehicle and the first target point. Thus, the number of vehicles between the point of the probe vehicle and the first target point can be counted by the satellite data, and the vehicle count information and the probe information can be associated with each other. This results in obtaining a traffic estimation table where the vehicle count information based on satellite data, which is the actual measurement value and the movement information based on probe information in association with each other.

According to the above configuration, the number of vehicles actually counted can be obtained as the estimated number of vehicles with reference to the traffic estimation table and obtaining the vehicle count information corresponding to the movement information obtained in the first process from the traffic estimation table. By using the vehicle count information based on the number of vehicles actually counted as the estimated number of vehicles, the vehicle traffic at a specific location such as an inflow road can be accurately estimated.
(2) In the traffic estimation apparatus of (1), when the inflow road includes a target section, the second target point may be at least one of a plurality of trajectory points in the target section, the plurality of trajectory points being included in the probe information of a probe vehicle having entered the inflow road. In this case, a trajectory point suitable for the second target point can be selected from among a plurality of trajectory points in the target section.
(3) In the traffic estimation apparatus of (2), the second target point may be a trajectory point farthest from the first target point among the plurality of trajectory points. In this case, the time required for passing through the first target point from the second target point becomes relatively long, and the amount of information reflected in the estimate can be increased.
(4) In the traffic estimation apparatus of (1), the second target point may be each of a plurality of trajectory points in a target section on the inflow road, the plurality of trajectory points being included in the probe information of a probe vehicle having entered the inflow road. In this case, a plurality of estimates can be calculated from the probe information of one probe vehicle, and a process for increasing the accuracy of the estimate can be performed using the plurality of estimates, such as obtaining the average value of the plurality of estimates.
(5) In the traffic estimation apparatus according to any one of (1) to (4), when the traffic estimation table does not have registered therein the vehicle count information corresponding to the movement information obtained in the first process, the second process may obtain the estimate with reference to an other traffic estimation table determined in advance. The other traffic estimation table is a table for obtaining an estimate of vehicle traffic on an other inflow road different from the inflow road, and is different from the traffic estimation table. In this case, a table from which the vehicle count information of the inflow road can be obtained accurately, such as a traffic estimation table of another inflow road having a road attribute similar to the road attribute of the inflow road, can be determined in advance as the other traffic estimation table. This allows for obtaining complementary estimates even when the vehicle count information corresponding to the movement information obtained in the first process is not registered in the traffic estimation table.
(6) In the traffic estimation apparatus of any one of (1) to (5), the first target point may include a point, a node, and a sag portion in a link included in the road network.
(7) In the traffic estimation apparatus according to any one of (1) to (6), the estimate may include the number of vehicles indicated by the vehicle count information, and a vehicle density from the second target point to the first target point.
(8) In the traffic estimation apparatus according to any one of (1) to (7), the communication unit may be capable of communicating with a providing device for the satellite data, and the processing unit may be configured to execute an update process for updating the traffic estimation table based on the satellite data acquired from the providing device. In this case, the latest satellite data is reflected in the traffic estimation table, and thus it is possible to further increase the accuracy of information registered in the traffic estimation table.
(9) In the traffic estimation apparatus of (8), the update process may include a process for acquiring the satellite data from the providing device, a determination process for determining, based on the probe information, whether the probe vehicle is present on the inflow road at the time of observation, and a process for determining whether to use the acquired satellite data to update the traffic estimation table, in accordance with a result of the determination process. In this case, the satellite data identifying the presence of the probe vehicle on the inflow road can be used to update the traffic estimation table.
(10) A traffic estimation apparatus according to another aspect of the embodiment includes a communication unit, and a processing unit configured to execute a traffic estimation process for obtaining an estimate of vehicle traffic on an inflow road connected to a first target point on a road network. The traffic estimation process includes a process for acquiring probe information of a plurality of probe vehicles via the communication unit, a first process for obtaining movement information based on the probe information, the movement information including a time taken for a probe vehicle located at a second target point on the inflow road to pass through the first target point and a distance from the second target point to the first target point, and a second process for obtaining the estimate with reference to a traffic estimation table, the traffic estimation table being updated based on satellite data obtained by observing an area including the first target point and the inflow road, the traffic estimation table has registered therein vehicle count information indicating the number of vehicles from a position of a probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other. The second process obtains the estimate based on the vehicle count information corresponding to the movement information obtained in the first process.

In the above configuration, the vehicle traffic at a specific location such as an inflow road can be accurately estimated.
(11) An update apparatus according to another aspect of the embodiment includes a communication unit configured to communicate with a providing device for satellite data and communicate with a probe vehicle, the satellite data being obtained by observing an area including a first target point on a road network and an inflow road to the first target point, a storage unit configured to store probe information of the probe vehicle, and a processing unit configured to execute an update process for updating a traffic estimation table based on the satellite data. The update process includes a process for acquiring the satellite data from the providing device, a process for counting the number of vehicles from a position of the probe vehicle present on the inflow road at a time of observation to the first target point, based on the satellite data, a process for obtaining movement information based on the probe information, the movement information including a time taken for the probe vehicle present on the inflow road at the time of observation to pass through the first target point from the position and a distance from the position to the first target point, and a process for registering, in the traffic estimation table, vehicle count information indicating the number of vehicles and the movement information in association with each other or updating the traffic estimation table.

According to the above configuration, it is possible to obtain a traffic estimation table where the vehicle count information obtained based on satellite data and the movement information obtained based on probe information in association with each other.
(12) In the update apparatus of (11), the update process may further include a determination process for determining, based on the probe information, whether at least one of a plurality of the probe vehicles is present on the inflow road at the time of observation. In this case, the satellite data identifying the presence of the probe vehicle on the inflow road can be used to update the traffic estimation table.
(13) An update apparatus according to another aspect of the embodiment includes a communication unit, and a processing unit configured to execute an update process for updating a traffic estimation table based on satellite data, the satellite data being obtained by observing an area including a first target point on a road network and an inflow road to the first target point. The update process includes a process for acquiring the satellite data and probe information of a probe vehicle via the communication unit, a process for counting the number of vehicles from a position of the probe vehicle present on the inflow road at a time of observation to the first target point, based on the satellite data, a process for obtaining movement information based on the probe information, the movement information including a time taken for the probe vehicle present on the inflow road at the time of observation to pass through the first target point from the position and a distance from the position to the first target point, and a process for registering, in the traffic estimation table, vehicle count information indicating the number of vehicles and the movement information in association with each other or updating the traffic estimation table.
(14) An embodiment according to another aspect is a traffic estimation method for obtaining an estimate of vehicle traffic on an inflow road connected to a first target point on a road network. The traffic estimation method includes obtaining movement information based on probe information, the movement information including a time taken for a probe vehicle located at a second target point on the inflow road to pass through the first target point and a distance from the second target point to the first target point, and obtaining the estimate with reference to a traffic estimation table, the traffic estimation table being updated based on satellite data obtained by observing an area including the first target point and the inflow road. The traffic estimation table has registered therein vehicle count information indicating the number of vehicles from a position of the probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other. The obtaining the estimate obtains the estimate based on the vehicle count information corresponding to the movement information obtained in the obtaining movement information.
(15) An embodiment according to another aspect is a computer program for causing a computer to execute a traffic estimation process for obtaining an estimate of vehicle traffic on an inflow road connected to a first target point on a road network. The computer program is a computer program causing the computer to execute obtaining movement information based on probe information, the movement information including a time taken for a probe vehicle located at a second target point on the inflow road to pass through the first target point and a distance from the second target point to the first target point, and obtaining the estimate with reference to a traffic estimation table, the traffic estimation table being updated based on satellite data obtained by observing an area including the first target point and the inflow road. The traffic estimation table has registered therein vehicle count information indicating the number of vehicles from a position of the probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other. The obtaining the estimate obtains the estimate based on the vehicle count information corresponding to the movement information obtained in the obtaining movement information.
(16) An embodiment according to another aspect is an update method for updating a traffic estimation table. The update method includes acquiring satellite data obtained by observing an area including a first target point on a road network and an inflow road to the first target point, counting the number of vehicles from a position of the probe vehicle present on the inflow road at a time of observation to the first target point, based on the satellite data, obtaining movement information based on probe information of the probe vehicle, the movement information including a time taken for the probe vehicle present on the inflow road at the time of observation to pass through the first target point from the position and a distance from the position to the first target point, and registering, in the traffic estimation table, vehicle count information indicating the number of vehicles and the movement information in association with each other or updating the traffic estimation table.
(17) An embodiment according to another aspect is a computer program for causing a computer to execute an update process for updating a traffic estimation table. The computer program causing the computer to execute acquiring satellite data obtained by observing an area including a first target point on a road network and an inflow road to the first target point, counting the number of vehicles from a position of the probe vehicle present on the inflow road at a time of observation to the first target point, based on the satellite data, obtaining movement information based on probe information of the probe vehicle, the movement information including a time taken for the probe vehicle present on the inflow road at the time of observation to pass through the first target point from the position and a distance from the position to the first target point, and registering, in the traffic estimation table, vehicle count information indicating the number of vehicles and the movement information in association with each other or updating the traffic estimation table.

### Details of Embodiment

Hereinafter, preferred embodiments will be described with reference to the drawings. It is noted that, at least a part of the embodiments described below may be combined as desired.

### Definition of Terms

Before describing the embodiment in detail, first, terms used in this specification will be defined. “Vehicle”: Refers to all vehicles that travel on a road. The power source of vehicles includes not only internal combustion engines but also electric vehicles and hybrid cars. In the embodiment, when simply referred to as “vehicle”, it includes both a probe vehicle having an in-vehicle apparatus capable of transmitting probe information and a normal vehicle not having the in-vehicle apparatus.

“Probe information”: Refers to various information about a probe vehicle traveling on a road sensed by the vehicle. The probe information is also referred to as probe data or floating car data. The probe information includes various kinds of vehicle data such as identification information of the probe vehicle, a vehicle position, a vehicle speed, a vehicle direction, and measurement times thereof.

“Probe vehicle”: Refers to a vehicle that senses probe information and transmits the probe information obtained by the sensing to the outside. The vehicles traveling on the road include both the probe vehicle and other vehicles.

### Overall Configuration of System

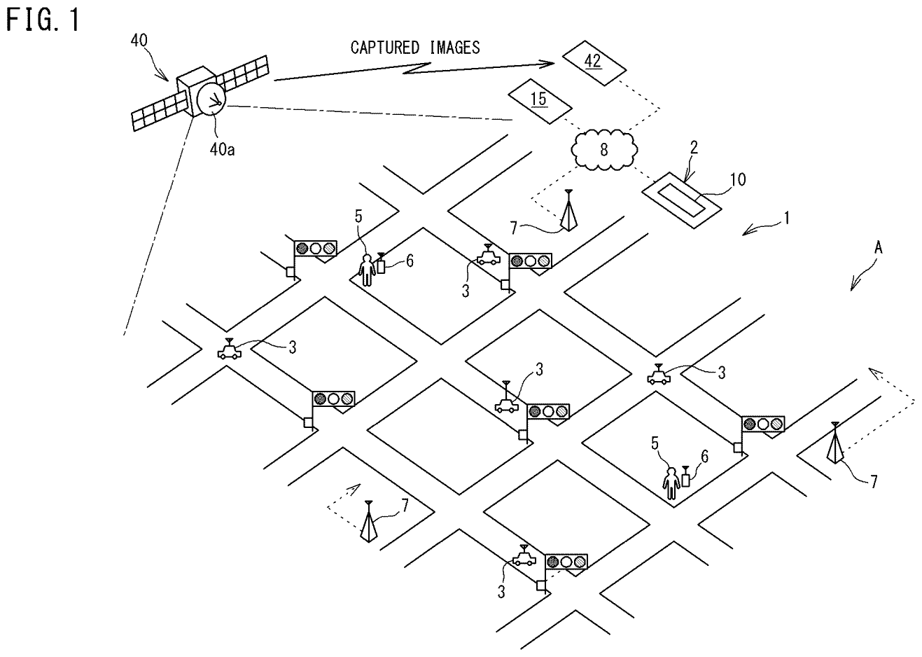

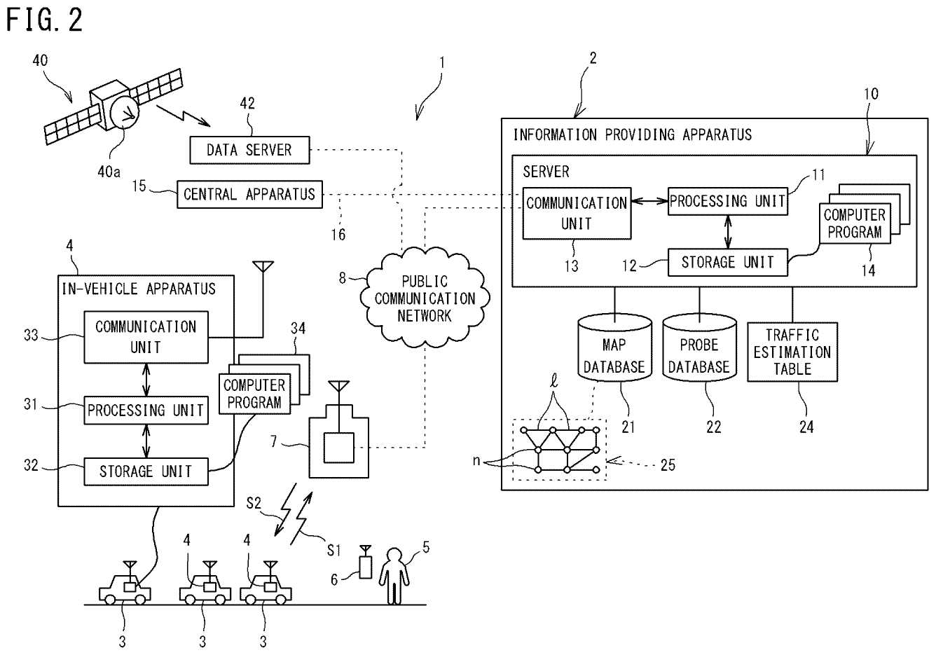

FIG. 1 is a perspective view showing an example of the overall configuration of an information providing system. FIG. 2 is a block diagram showing an example of the internal configuration of an information providing apparatus included in the information providing system and an in-vehicle apparatus of a probe vehicle. As shown in FIG. 1 and FIG. 2, an information providing system 1 includes an information providing apparatus 2 and an in-vehicle apparatus 4 mounted on a probe vehicle 3. Information providing apparatus 2 has a function of communicating with in-vehicle apparatus 4 and a function acquiring satellite data. The satellite data is data indicating a result of observation of the ground by an artificial satellite 40, and includes a captured image of the ground, and the like. In-vehicle apparatus 4 has a function of communicating with information providing apparatus 2 and transmitting probe information of probe vehicle 3.

Information providing system 1 of this embodiment has the function of generating traffic information indicating the vehicle traffic or the like based on satellite data and probe information, and distributing it to in-vehicle apparatus 4 of probe vehicles 3 and user terminals 6 of other users 5.

Information providing apparatus 2 includes a computer such as a server. Information providing apparatus 2 may be either an on-premise server or a cloud server. The operation subject of information providing apparatus 2 may be, for example, a public business operator in charge of traffic control, a manufacturer of probe vehicle 3, or an IT company that performs various information providing businesses. Information providing apparatus 2 has a function of calculating an estimate of vehicle traffic in an area A, which is a part of the road network, based on the satellite data and the probe information. Further, information providing apparatus 2 has a function of distributing the obtained estimate as traffic information to in-vehicle apparatus 4 of probe vehicle 3, user terminal 6 of other user 5, and the like.

In-vehicle apparatus 4 of probe vehicle 3 can perform wireless communication with wireless base stations 7 (for example, mobile base stations) in various places. Wireless base station 7 is capable of communicating with information providing apparatus 2 via a public communication network 8 such as the Internet. In-vehicle apparatus 4 can wirelessly transmit an uplink information S1 addressed to information providing apparatus 2 to wireless base station 7. Information providing apparatus 2 can transmit a downlink information S2 addressed to specific in-vehicle apparatus 4 to public communication network 8.

User terminal 6 consists of a data communication terminal carried by user 5, such as a smartphone, a tablet computer, or a notebook computer. User terminal 6 can perform wireless communication with wireless base stations 7 in various places. User terminal 6 can wirelessly transmit uplink information S1 addressed to information providing apparatus 2 to wireless base station 7. Information providing apparatus 2 can transmit downlink information S2 addressed to specific user terminal 6 to public communication network 8.

Although user terminal 6 consists of a portable terminal is illustrated in FIG. 1 and FIG. 2, user terminal 6 may be a computer device such as a desktop personal computer installed indoors. In this case, user terminal 6 communicates with information providing apparatus 2 via a fixed communication network that is connected to public communication network 8 by an optical communication line or the like. Further, information providing apparatus 2 can also provide information to another server or the like (not shown) that communicates via public communication network 8.

Artificial satellite 40 flying in the sky is, for example, a commercial satellite. Artificial satellite 40 has a function of a synthetic aperture radar (SAR) or the like. Artificial satellite 40 includes an antenna 40a. Artificial satellite 40 observes the ground by receiving a reflected wave from the ground by antenna 40a. Artificial satellite 40 observes the ground at a constant time interval (for example, an interval of 10 minutes to several days). Artificial satellite 40 outputs an observation result of observing the ground as observation data (snapshot of time of observation). Data is transmitted from artificial satellite 40 in the sky to a data server 42 on the ground.

Data server 42 has a function of storing observation data. Thus, data server 42 stores observation data at a predetermined time interval. Data server 42 is connected to public communication network 8. Data server 42 is capable of connecting to an external device via public communication network 8. Data server 42 has a function of providing observation data as satellite data to an external device that is a request source corresponding to a request from the external device. The satellite data provided from data server 42 includes position information of the captured image and captured time information in addition to the captured image. The captured image is an image of the ground captured by artificial satellite 40. The captured image can be generated based on the observation data. Further, the satellite data may include complex data before being converted into the captured image. The complex data is data obtained based on the observation data. The resolution of the captured image included in the satellite data is several tens of centimeters. Thus, the vehicle on the ground is captured so as to be clearly capable of recognizing by the captured image of the satellite data. Further, the position of the captured vehicle can also be recognized by the position information of the captured image.

Information providing apparatus 2 of the embodiment transmits a request for providing satellite data including a captured image obtained by capturing area A to data server 42. Data server 42 transmits the satellite data corresponding to the reception of the request to information providing apparatus 2.

### Configuration of Information Providing Apparatus

As shown in FIG. 2, information providing apparatus 2 includes a server 10. Server 10 is configured by one or a plurality of computers. Server 10 includes a processing unit 11, a storage unit 12, and a communication unit 13. Storage unit 12 is a storage device consisting of a nonvolatile memory (storage medium) such as a hard disk drive (HDD) or a solid state drive (SSD) and a volatile memory (storage medium) such as a random access memory. Storage unit 12 stores a computer program 14 to be executed by processing unit 11 and other necessary information. Further, storage unit 12 stores various databases 21, 22 and a table 24.

Processing unit 11 includes an arithmetic process device such as a central processing unit (CPU) that reads computer program 14 stored in storage unit 12 and performs an information process in accordance with program 14. Processing unit 11 executes computer program 14 stored in a computer-readable non-transitory recording medium such as storage unit 12 to implement various process functions of information providing apparatus 2.

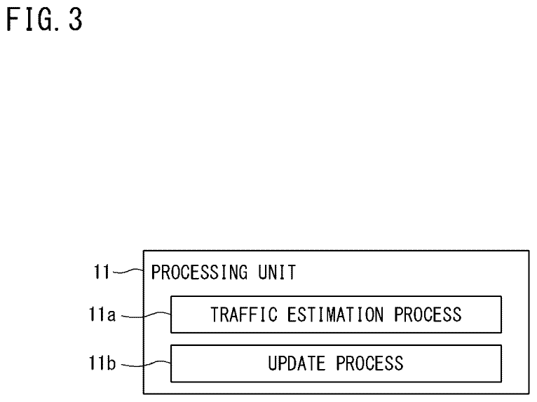

FIG. 3 is a block diagram showing a part of the process functions of processing unit 11. As shown in FIG. 3, processing unit 11 has a function of executing a traffic estimation process 11a and an update process 11b. Traffic estimation process 11a is a process for obtaining an estimate of vehicle traffic on an inflow road connected to a first target point on the road network with reference to traffic estimation table 24 described later. Update process 11b is a process for updating traffic estimation table 24 based on the satellite data. These processes 11a and 11b will be described in detail later.

Communication unit 13 shown in FIG. 2 is a communication interface for communicating with wireless base station 7 and data server 42 via public communication network 8. Communication unit 13 is capable of receiving uplink information S1 transmitted from wireless base station 7 to the own device. Communication unit 13 is capable of transmitting downlink information S2 generated by the own device to wireless base station 7. Further, communication unit 13 is capable of receiving satellite data transmitted from data server 42 via public communication network 8. Communication unit 13 may be connected to a central apparatus 15 of a traffic control center via predetermined leased line 16. Central apparatus 15 is a server computer that comprehensively determines signal control parameters of intersections included in a predetermined traffic control area.

Databases 21, 22 and table 24 are databases and tables constructed in a large-capacity storage such as an HDD or an SSD included in storage unit 12. The mass storage including databases 21, 22 and table 24 may be one or more external storage devices connected to server 10 so as to be capable of transferring data. More specifically, databases 21 and 22 include map database 21 and probe database 22. Table 24 includes traffic estimation table 24.

Map database 21 stores road map data (digital road map) 25 covering the whole country. Road map data 25 includes “node data”, “link data”, and the like. A node is a nodal point on a road network such as an intersection. A link is a section connecting a pair of adjacent nodes. The node includes an entrance and an exit of the service area in addition to the intersection. The “node data” is data in which an ID assigned to a domestic node and position information of the node in association with each other. The “link data” consists of data in which the following Information 1) to Information 4) and the link ID of a specific link assigned to a road in Japan in association with each other.
Information 1) Position information of start point, end point, and interpolation point of specific link
Information 2) Link ID connected to start point of specific link
Information 3) Link ID connected to end point of specific link
Information 4) Link cost of specific link

Road map data 25 constitutes a network corresponding to the actual road line shape and the road traveling direction. Thus, road map data 25 is a network in which road sections between nodes representing intersections are connected by a directed links 1 (lowercase letter 1). Specifically, road map data 25 consists of a directed graph in which a node n is set for each intersection and nodes n are connected by a pair of directed links 1 in opposite directions. Thus, in the case of a one-way road, only the one way directed link 1 is connected to node n.

Road map data 25 also includes road attribute information of the road corresponding to directed link 1. The road attribute information includes, for example, the following Information 1) to Information 6).
Information 1) Road type information indicating whether the road is a general road or a toll road. Information 2) Number of lanes of road
Information 3) Road width for each lane
Information 4) Road radius of curvature
Information 5) Road speed limit (for example, legal speed limit)
Information 6) Facility type information indicating a type of facility such as a tollgate, an interchange, or a service area

Further, road map data 25 also includes specific point information. The specific point is a point which does not appear as a link or a node and causes a traffic jam, such as a sag portion on a highway. The specific point information is information indicating the position of the specific point. The specific point appears at a position on directed link 1.

The probe information received from probe vehicle 3 registered in advance in information providing apparatus 2 is stored in probe database 22 for each identification information of probe vehicle 3. The probe information to be stored includes at least the vehicle position and the passage time. The probe information may include vehicle data such as a vehicle speed, a vehicle direction, and state information (stop/travel events) of the vehicle. The sensing cycle of the probe information is a time interval at which the travel history of probe vehicle 3 can be accurately identified, and is, for example, 0.1 to 1.0 seconds. Thus, the traveling trajectory of probe vehicle 3 is stored in probe database 22 as a plurality of discrete trajectory points. At least a vehicle position and a passage time thereof are associated with each of the plurality of trajectory points. Traffic estimation table 24 will be described in detail later.

### Configuration of In-Vehicle Apparatus

As shown in FIG. 2, in-vehicle apparatus 4 consists of a computer apparatus including a processing unit 31, a storage unit 32, a communication unit 33, and the like. Processing unit 31 includes an arithmetic process device such as a CPU. Storage unit 32 is a storage device including a nonvolatile memory (recording medium) such as an HDD or an SSD and a volatile memory (recording medium) such as a random access memory. A computer program 34 of in-vehicle apparatus 4 includes a program for causing the CPU of processing unit 31 to execute sensing and generation of probe information, a route search process of probe vehicle 3, and an image process for displaying a search result on the display of the navigation apparatus, and the like. Processing unit 31 reads computer program 34 stored in storage unit 32 and performs various information processes in accordance with program 34.

Communication unit 33 consists of a wireless communication device permanently mounted on probe vehicle 3 or a data communication terminal (for example, a smartphone, a tablet computer, or a node personal computer) temporarily mounted on probe vehicle 3. Communication unit 33 includes, for example, a global positioning system (GPS) receiver. Processing unit 31 monitors the current position of the vehicle in substantially real-time based on the position information of the GPS received by communication unit 33. Although the use of global navigation satellite systems such as GPS is preferable for positioning, other methods may also be used.

Processing unit 31 measures vehicle data such as the vehicle position, the vehicle speed, the vehicle direction, and the CAN information of probe vehicle 3, which is the own vehicle, at predetermined sensing intervals (for example, 0.5 to 1.0 seconds), and records the vehicle data in storage unit 32 together with the measurement time. When the vehicle data is stored in storage unit 32 for a predetermined recording time (for example, 5 minutes), communication unit 33 generates probe information including the stored vehicle data and identification information of the own vehicle (probe vehicle 3), and uplink-transmits the generated probe information to information providing apparatus 2.

In-vehicle apparatus 4 includes an input/output interface (not shown). The input/output interface consists of, for example, an input/output device attached to the navigation device or an input/output device of a data communication terminal mounted on probe vehicle 3.

### About Traffic Estimation Process

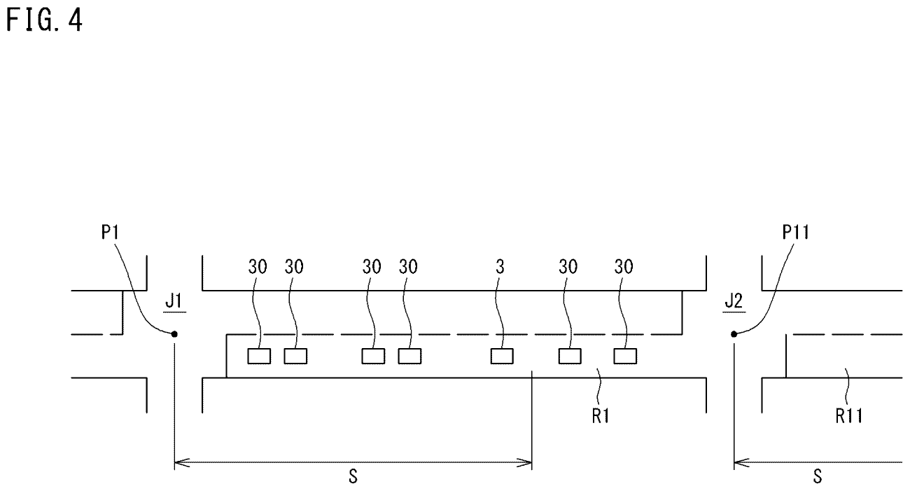

FIG. 4 is a diagram for explaining a traffic estimation process. Processing unit 11 of the embodiment executes traffic estimation process 11a to calculate an estimate of traffic on the inflow road connected to a first target point P1 on the road network. FIG. 4 shows a case where first target point P1 is set at an intersection J1. Processing unit 11 can calculate the estimate for each of the four inflow roads connected to intersection J1. The following description will be made by focusing on one inflow road R1 among the four inflow roads. Inflow road R1 connects an intersection J2 and intersection J1. Intersection J2 is an intersection positioned on the upstream side of intersection J1. Thus, each vehicle shown in FIG. 4 travels from the right side to the left side of the drawing.

Although FIG. 4 shows the case where first target point P1 is set at the center of intersection JI, first target point PI may be set at any position in intersection J1. Further, first target point PI may be set as a stop line for inflow road R1 at intersection J1. Furthermore, at least intersection J1, inflow road R1, intersection J2, and an inflow road R11 of intersection J2 are positioned in area A.

Inflow road R1 includes a target section S. Target section S is a section set for processing unit 11 to obtain the estimated number of vehicles. Processing unit 11 estimates the number of vehicles present between probe vehicles 3 positioned in target section S and intersection J1. In the embodiment, the upstream point defining target section S is positioned between intersection J1 and intersection J2. The downstream point defining target section S is positioned at intersection J1 (first target point P1). It is noted that, target section S can be set as desired within the section from intersection J1 to intersection J2. Thus, target section S may be set in the entire region from intersection JI to intersection J2 in inflow road RI, or both the upstream point and the downstream point of target section S may be positioned between intersection J1 and intersection J2.

As shown in FIG. 4, when probe vehicle 3 is present in target section S, processing unit 11 calculates the estimate of the number of vehicles positioned between a predetermined point (second target point) indicating the position of probe vehicle 3 in target section S and first target point P1. In FIG. 4, when probe vehicle 3 is positioned at the second target point, processing unit 11 estimates the number of vehicles 30 positioned between probe vehicle 3 and first target point P1. It is noted that, vehicle 30 includes probe vehicle 3 and a normal vehicle.

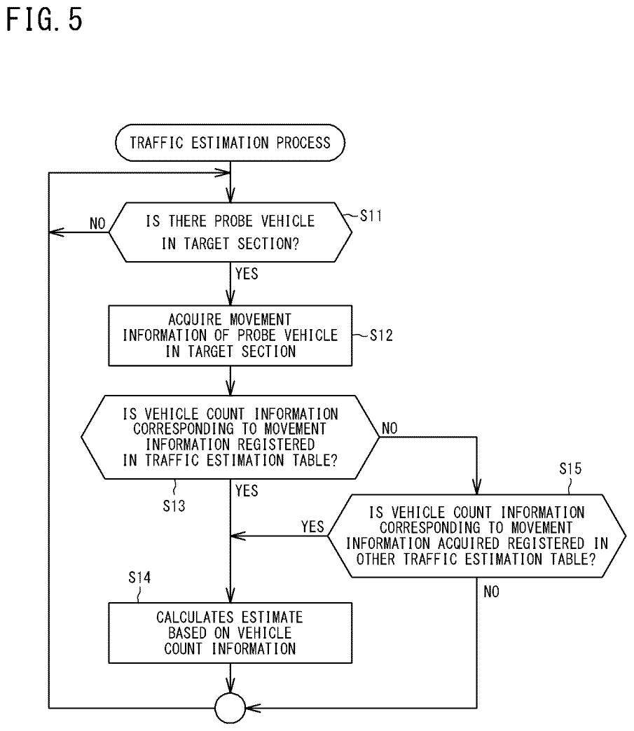

FIG. 5 is a flow chart showing an example of the traffic estimation process. In traffic estimation process 11a, processing unit 11 first determines whether or not there is probe vehicle 3 that has entered target section S (step S11 in FIG. 5). Processing unit 11 determines whether or not there is probe vehicle 3 that entered target section S with reference to probe database 22. Processing unit 11 repeats step S11 until it is determined that there is probe vehicle 3 that has entered target section S.

When it is determined in step S11 that there is probe vehicle 3 that has entered target section S, processing unit 11 acquires the movement information of probe vehicle 3 in target section S (step S12: first process in FIG. 5). The movement information includes a time T required for probe vehicle 3 positioned at a second target point P2 on inflow road R1 to pass through first target point P1 (intersection J1) and a distance L from second target point P2 to first target point P1 (intersection J1). Second target point P2 is a point for obtaining the estimated number of vehicles using probe vehicle 3.

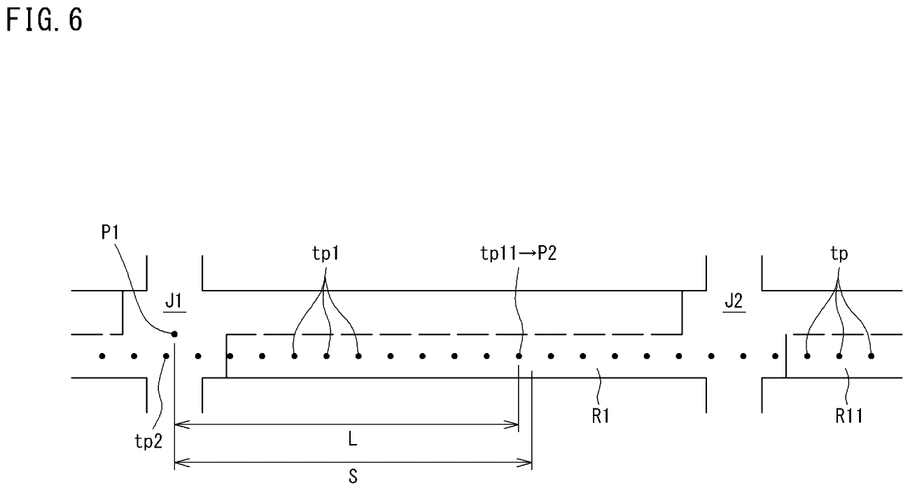

FIG. 6 is a diagram schematically showing the trajectory point of probe vehicle 3 entering inflow road R1. A plurality of trajectory points tp shown in FIG. 6 are trajectory points when probe vehicle 3 passes straight through intersection J2 and further passes straight through inflow road R1 and intersection J1. It is noted that, in FIG. 6, the interval between adjacent trajectory points tp is shown relatively wide for easy understanding. Since probe vehicle 3 passes through inflow road R1 and intersection J1 in a straight line, the plurality of trajectory points tp are arranged in a straight line in FIG. 6.

Processing unit 11 specifies a plurality of trajectory points tp1 in target section S among a plurality of trajectory points tp included in the probe information of probe vehicle 3 that has entered inflow road R1. Further, processing unit 11 sets trajectory points tp11 farthest from first target point P1 among the plurality of trajectory point tp1 as second target point P2.

When second target point P2 is determined, processing unit 11 obtains distance L based on the probe information. Further, processing unit 11 also obtains time T based on the probe information. Processing unit 11 obtains a difference between the passage time at a trajectory point tp2 immediately after probe vehicle 3 entering inflow road R1 passes through first target point Pl and the passage time at trajectory point tp11. Processing unit 11 sets this difference as time T.

As described above, processing unit 11 acquires the movement information including time T and distance L based on the probe information (step S12 in FIG. 5).

As shown in FIG. 5, when the movement information is acquired, processing unit 11 proceeds to step S13, and determines whether or not the vehicle count information corresponding to the acquired movement information is registered in traffic estimation table 24 with reference to traffic estimation table 24 (step S13 in FIG. 5).

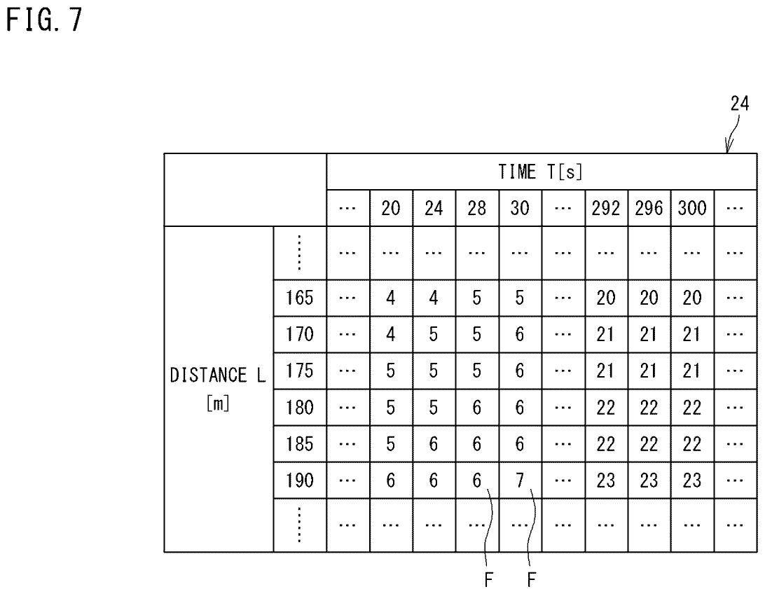

FIG. 7 is a diagram showing an example of traffic estimation table 24. Traffic estimation table 24 is a table updated based on the satellite data obtained by observing area A including first target point P1 and inflow road R1. Traffic estimation table 24 is generated for each inflow road R1.

In traffic estimation table 24, vehicle count information and movement information are registered in association with each other. The vehicle count information is information indicating the number of vehicles from the position of probe vehicle 3 present on inflow road R1 to first target point P1 at the time of observation, which is counted based on the captured image of the satellite data. That is, the vehicle count information is an actual measurement value counted based on the satellite data. It is noted that, the time of observation is the time when artificial satellite 40 performs observation for obtaining the satellite data (observation data), that is, the captured time.

The movement information registered in traffic estimation table 24 is movement information of probe vehicle 3 on inflow road R1 at the time of observation, which is obtained based on the probe information. The movement information includes time T required for probe vehicle 3 present on inflow road R1 at time of observation to pass through first target point P1 from the position at time of observation and distance L from the position of probe vehicle 3 at time of observation to first target point P1.

Each row of traffic estimation table 24 corresponds to distance L of the movement information. Each column of traffic estimation table 24 corresponds to time T of the movement information. In each field F of traffic estimation table 24, vehicle count information corresponding to a combination of distance L and time T is registered.

For example, the vehicle count information corresponding to the movement information in which distance L is 170 meters and time T is 24 seconds is five. Further, the vehicle count information corresponding to the movement information in which distance L is 170 meters and time T is 292 seconds is 21.

Processing unit 11 determines whether or not the combination of distance L and time T included in the movement information acquired in step S12 in FIG. 5 and the vehicle count information corresponding to the combination are registered in traffic estimation table 24 with reference to traffic estimation table 24 (step S13 in FIG. 5). When it is determined in step S13 that the vehicle count information corresponding to the movement information acquired in step S12 is registered in table 24, processing unit 11 proceeds to step S14, and calculates the estimate of the vehicle traffic based on the vehicle count information corresponding to the movement information (step S14: second process in FIG. 5).

The vehicle count information corresponding to the movement information acquired in step S12 indicates the estimated number of vehicles between second target point P2 and first target point Pl based on the actual measurement value by the satellite data. In this way, processing unit 11 obtains the estimated number of vehicles between second target point P2 and first target point P1, and calculates the estimate of the vehicle traffic. The estimate includes the number of vehicles indicated by the vehicle count information, the vehicle density from second target point P2 to first target point P1, and the like. After calculating the estimate, processing unit 11 returns to step S11 again and repeats the same process. The obtained estimate is distributed to in-vehicle apparatus 4 of probe vehicle 3, user terminal 6 of other user 5, and the like as traffic information.

During the time of observation of satellite data that is the observation result of area A, which includes first target point P1 and inflow road R1, when probe vehicle 3 is present positioned on inflow road R1, based on the satellite data, it is possible to detect not only the presence of probe vehicle 3 but also the presence of vehicle 30 lined up on inflow road R1 from the position of that probe vehicle 3 to first target point P1. Thus, the number of vehicles between the point of probe vehicle 3 and first target point P1 can be counted with the satellite data, and the vehicle count information and the probe information can be associated with each other.

More specifically, when probe vehicle 3 positioned on inflow road R1 is also captured in the captured image obtained by capturing area A, vehicle 30 on inflow road R1 arranged between the point of probe vehicle 3 and first target point Pl is also captured. Thus, the number of vehicles between the point of probe vehicle 3 and first target point Pl can be counted with the captured image, and the vehicle count information and the probe information can be associated with each other. Thus, traffic estimation table 24 in which the vehicle count information which is the actual measurement value based on the satellite data (captured image) and the movement information based on the probe information in association with each other is obtained.

According to the above configuration, the number of vehicles actually counted can be acquired as the estimated number of vehicles by obtaining the vehicle count information corresponding to the movement information obtained in step S12 from traffic estimation table 24 with reference to traffic estimation table 24. By using the vehicle count information based on the number of vehicles actually counted as the estimated number of vehicles, the traffic of vehicle 30 at a specific location such as inflow road R1 can be accurately estimated.

It is noted that, first target point P1 is set to a specific point such as a point, a node, or a sag portion in a link included in area A. For example, a first target point P11 is set for intersection J2 in FIG. 4. First target point P11 is another first target point different from first target point P1. First target point P11 is connected to inflow road R11. Inflow road R11 is another inflow road different from inflow road R1. Processing unit 11 also obtains an estimate of traffic on inflow road R11 connected to first target point P11 (intersection J2). In this case, traffic estimation table 24 is also generated for inflow road R11 of intersection J2. Processing unit 11 calculates an estimate of the traffic on inflow road R11 by using traffic estimation table 24 (other traffic estimation table) of inflow road R11.

First target point P11 (intersection J2) is positioned next to first target point Pl (intersection J1). That is, first target point P11 is positioned around first target point P1. Further, at least a part of the road attribute information of inflow road R11 is the same as the road attribute information of inflow road R1. In the embodiment, first target point P11 being positioned around first target point Pl includes, for example, a case where first target point P11 and first target point P1 are both set to an intersection J11 and intersection J1, and intersection J11 and intersection JI are adjacent to each other as described above, and a case where other intersections are present at several positions between intersection J11 and intersection J1. In this case, processing unit 11 may calculate the estimate of the traffic on inflow road R1 with reference to traffic estimation table 24 of inflow road R11.

In FIG. 5, when it is determined in step S13 that the vehicle count information associated with the movement information acquired in step S12 is not registered in table 24, processing unit 11 proceeds to step S15. Traffic estimation table 24 is updated based on the satellite data. The satellite data may include a shadow area. The shadow area is, for example, an area in which a shadow is generated when a part of inflow road RI is shaded by a building or the like. Thus, movement information and vehicle count information that cannot be acquired based on the satellite data may be present. The movement information and the vehicle count information that cannot be acquired are not registered in traffic estimation table 24. Thus, the vehicle count information corresponding to the movement information acquired in step S12 may not be registered in table 24.

In step S15, processing unit 11 determines whether or not the combination of distance L and time T included in the movement information acquired in step S12 and the vehicle count information corresponding to the combination are registered in traffic estimation table 24 of inflow road R11 with reference to traffic estimation table 24 (other traffic estimation table) of inflow road R11 (step S15 in FIG. 5). It is noted that, traffic estimation table 24 of inflow road R11 referred to by processing unit 11 in step S15 is set in advance as the other traffic estimation table.

When it is determined in step S15 that the vehicle count information corresponding to the movement information acquired in step S12 is registered in table 24 of inflow road R11, processing unit 11 proceeds to step S14 and calculates the estimate of the vehicle traffic in inflow road R1 based on the vehicle count information corresponding to the movement information (step S14 in FIG. 5). As described above, at least a part of the road attribute information of inflow road R11 is the same as the road attribute information of inflow road R1. Thus, it can be said that the road attribute information of inflow road R1 and the road attribute information of inflow road R11 are similar. Since the road attribute information of inflow road R1 is similar to the road attribute information of inflow road R11, the traffic of inflow road R1 and the traffic of inflow road R11 approximate each other. In this case, the vehicle count information of inflow road R1 obtained using traffic estimation table 24 of inflow road R11 can be obtained with accuracy that is not inferior comparable to that of the vehicle count information of inflow road R1 obtained using traffic estimation table 24 of inflow road R1. That is, in the embodiment, by determining in advance the other traffic estimation table from which the vehicle count information of inflow road R1 can be accurately obtained, the estimate can be calculated even when the vehicle count information corresponding to the movement information obtained in step S12 is not registered in traffic estimation table 24 of first target point P1.

In the embodiment, the vehicle count information can be accurately obtained by referring to the traffic estimation tables of first target point P11 and inflow road R11 having the road attribute similar to the road attribute of first target point P1 and inflow road R1. As a result, this allows for obtaining complementary estimates even when the vehicle count information corresponding to the movement information obtained in step S12 is not registered in traffic estimation table 24 of first target point P1.

It is noted that, the case where at least a part of the road attribute information of inflow road R11 is the same as the road attribute information of inflow road R1 means, for example, a case where at least one of the above-described six pieces of road attribute information is the same as each other.

In FIG. 5, when it is determined in step S15 that the vehicle count information corresponding to the movement information acquired in step S12 is not registered in table 24 of inflow road R11, processing unit 11 returns to step S11 again and repeats the same process.

It is noted that, in the traffic estimation process, as shown in FIG. 6, second target point P2 is illustrated as the farthest trajectory point tp11 from first target point Pl among the plurality of trajectory points tp1. However, second target point P2 may be any one trajectory point tp1 among the plurality of trajectory points tp1. In this case, trajectory point tp1 suitable for second target point P2 can be set from among the plurality of trajectory points tp1 in target section S. It is noted that, as in the embodiment, by setting second target point P2 to the farthest trajectory point tp11 from first target point P1, the time required for passing through first target point Pl from second target point P2 becomes relatively long, and the amount of information reflected in the estimate to be obtained later can be increased.

Further, a plurality of trajectory points tp1 may be selected from the plurality of trajectory points tp1, and the plurality of selected trajectory points tp1 may be set as the plurality of second target points P2. Further, each of the plurality of trajectory points tp1 may be set as second target point P2. In this case, a plurality of estimates can be obtained from the probe information of one probe vehicle 3, and a process for increasing the accuracy of the estimates can be performed using the plurality of estimates, such as calculating the average value of the plurality of estimates.

Further, when a plurality of probe vehicles 3 are present in target section S at the same time, the estimate may be calculated based on all probe vehicles 3 or may be calculated based on some of the plurality of probe vehicles 3.

### About Update Process

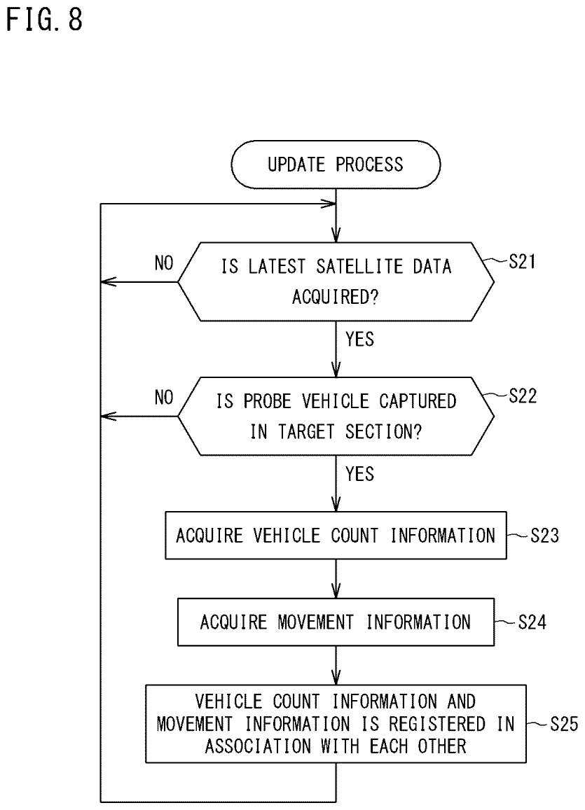

FIG. 8 is a flowchart showing an example of the update process. Processing unit 11 of the embodiment executes update process 11b and updates traffic estimation table 24. Processing unit 11 executes the update process asynchronously with the traffic estimation process.

In the update process, processing unit 11 first determines whether or not the latest satellite data is acquired (step S21 in FIG. 8). Processing unit 11 periodically transmits a request for providing satellite data to data server 42 (FIG. 1 and FIG. 2). Processing unit 11 determines whether the latest satellite data is acquired with reference to the satellite data transmitted from data server 42 corresponding to the request. The latest satellite data is satellite data whose captured time is later than that of the satellite data acquired immediately before.

Processing unit 11 repeats step S21 until it is determined that the latest satellite data is acquired. When it is determined that the latest satellite data is acquired, processing unit 11 determines whether or not probe vehicle 3 is captured in target section S (inflow road R1) in the captured image included in the latest satellite data (step S22 in FIG. 8). In step S22, processing unit 11 determines whether probe vehicle 3 is present in target section S at the captured time included in the satellite data with reference to the probe information. When probe vehicle 3 is present in target section S at the captured time included in the satellite data, it can be determined that probe vehicle 3 is captured in target section S in the satellite data (captured image). When it is determined that probe vehicle 3 is not captured in target section S in the satellite data, processing unit 11 returns to step S21 and repeats steps S21 and S22. In this way, in step S22, a determination process is executed to determine whether probe vehicle 3 is present in target section S (inflow road) in the time of observation based on the probe information.

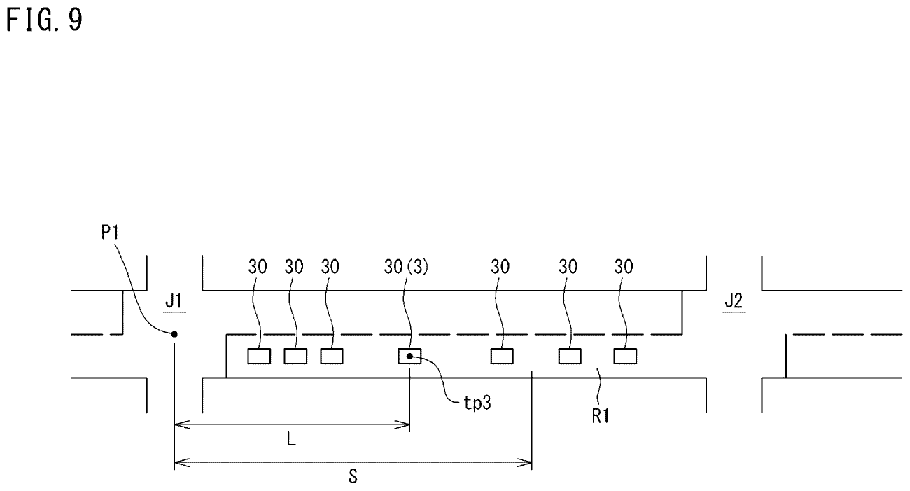

Processing unit 11, which has determined that probe vehicle 3 is captured in target section S in the satellite data, proceeds to step S23 in FIG. 8, and acquires the vehicle count information (step S23 in FIG. 8). FIG. 9 is a diagram schematically showing a part of captured images of first target point P1 and inflow road R1 included in the satellite data. Processing unit 11 performs image processing or the like on the captured image included in the satellite data in order to identify vehicle 30 on inflow road R1. Processing unit 11 identifies vehicle 30 on inflow road R1 based on the process image after the image process. In target section S in FIG. 9, five vehicles 30 is present. Processing unit 11 identifies these five vehicles 30 and acquires position information of each of five vehicles 30.

Next, processing unit 11 compares a trajectory point tp3 of probe vehicle 3 determined to be captured in target section S in the satellite data with the position information of each of five vehicles 30. It is noted that, trajectory point tp3 used for comparison is a trajectory point at the captured time included in the satellite data. As a result of the comparison, processing unit 11 specifies vehicle 30 having the position information overlapping the position of trajectory point tp3 among five vehicles 30 as probe vehicle 3. In FIG. 9, the position of fourth vehicle 30 from intersection JI and the position of trajectory point tp3 overlap. Thus, probe vehicle 3 on target section S captured in the satellite data can be specified. Processing unit 11 counts the number of vehicles between the position of specified probe vehicle 3 (trajectory point tp3) and first target point P1, and acquires the counted number of vehicles as vehicle count information. In FIG. 9, processing unit 11 counts the number of vehicles from the position of probe vehicle 3 (trajectory point tp3) to first target point P1 as four vehicles including probe vehicle 3.

In FIG. 8, when the vehicle count information is acquired in step S23, processing unit 11 proceeds to step S24, and acquires the movement information of probe vehicle 3 positioned at trajectory point tp3 (step S24 in FIG. 8). The movement information includes time T required for probe vehicle 3 captured in the satellite data to pass through first target point Pl from the position (trajectory point tp3) and distance L from the position (trajectory point tp3) to first target point P1. The method of obtaining time T and distance L is the same as the method of obtaining time T and distance L included in the movement information in the traffic estimation process. Thus, the movement information in step S24 is acquired by the same method as the traffic estimation process.

When the movement information is acquired, processing unit 11 registers the vehicle count information acquired in step S23 and the movement information acquired in step S24 in traffic estimation table 24 is registered in association with each other (step S25 in FIG. 8), and returns to step S21.

Further, in step S25, for example, when the movement information acquired in step S24 has already been registered in traffic estimation table 24, processing unit 11 updates traffic estimation table 24 by overwriting the newly acquired movement information and the vehicle count information corresponding thereto. Thus, the latest satellite data is reflected in traffic estimation table 24, and it is possible to further increase the accuracy of information registered in traffic estimation table 24.

By repeating the update process, many patterns of combinations of the movement information (time T and distance L) and the vehicle count information are registered, and traffic estimation table 24 without omission is generated. In this way, by executing the update process, it is possible to obtain traffic estimation table 24 in which the vehicle count information obtained based on the satellite data and the movement information obtained based on the probe information in association with each other.

Further, in the embodiment, in step S22 in FIG. 8, a process of determining whether or not probe vehicle 3 is captured in target section S of inflow road R1 in the satellite data acquired based on the probe information (determination process) is included. In this case, satellite data identifying the presence of probe vehicle 3 in target section S (inflow road) can be used to update the traffic estimation table. That is, the captured image in which probe vehicle 3 is captured in target section S is specified without using the captured image in which probe vehicle 3 is not captured in target section S, and can be used for updating traffic estimation table 24.

Further, in the update process of the embodiment, the case where the number of probe vehicles 3 captured in target section S in the satellite data is one is illustrated, but a case where a plurality of probe vehicles 3 are captured is also considered. When there are a plurality of probe vehicles 3 whose images have been captured, the update process is performed for each of the plurality of probe vehicles 3.

It is noted that, in the update process of the embodiment, it may be determined that same probe vehicle 3 is present in each of the plurality of satellite data because inflow road R1 is congested. In this case, the update process is performed for each of same probe vehicles 3 present in the plurality of pieces of satellite data.

It is noted that, in the embodiment, it is determined whether probe vehicle 3 is present in target section S, and when probe vehicle 3 is present, the movement information of probe vehicle 3 is acquired. The movement information includes time T required for probe vehicle 3 to pass through first target point P1 (intersection J1). Thus, when time T is extremely large or probe vehicle 3 has not left target section S, there is a possibility that some abnormality has occurred in target section S. For example, when vehicle 3 cannot move due to a traffic accident or heavy snow, it is difficult for probe vehicle 3 to exit target section S. Thus, in the embodiment, when time T included in the movement information acquired is larger than time T registered in traffic estimation table 24 or when time T cannot be acquired, it is possible to determine that some abnormality has occurred in target section S.

### About Variations of First Target Point P1

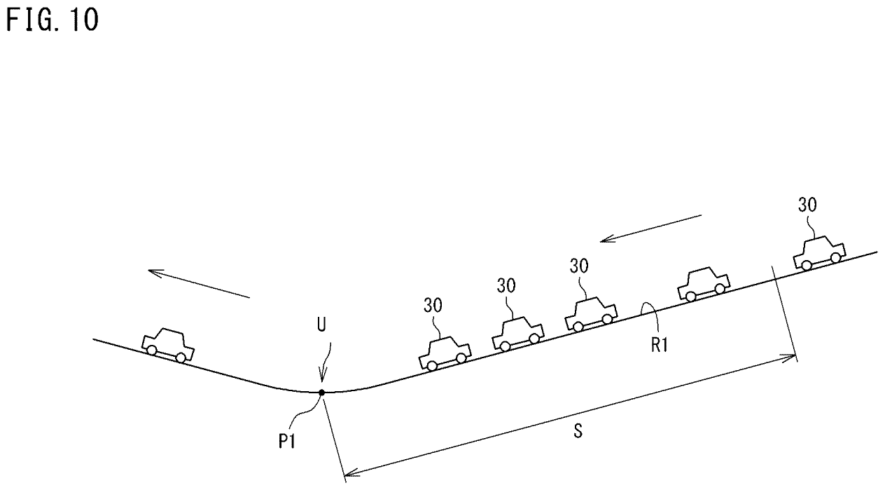

FIG. 10 is a schematic side view of a sag portion U on a highway. In FIG. 10, each vehicle 30 travels from the right side to the left side of the paper. As shown in FIG. 10, sag portion U is a portion where a road changes from a downhill slope to an uphill slope. In FIG. 10, first target point P1 is set in sag portion U. Target section S is set for inflow road R1 which is a downhill connected to sag portion U. Sag portion U is a specific point, and is positioned at a predetermined point in the link. Processing unit 11 can also obtain the estimates of the traffic of first target point P1 and inflow road R1 as shown in FIG. 10.

In general, congestion is likely to occur in sag portion U. In contrast, processing unit 11 can calculate the estimate of the vehicle traffic on inflow road R1 of sag portion U, and can accurately estimate the traffic of sag portion U where congestion is likely to occur.

### Others

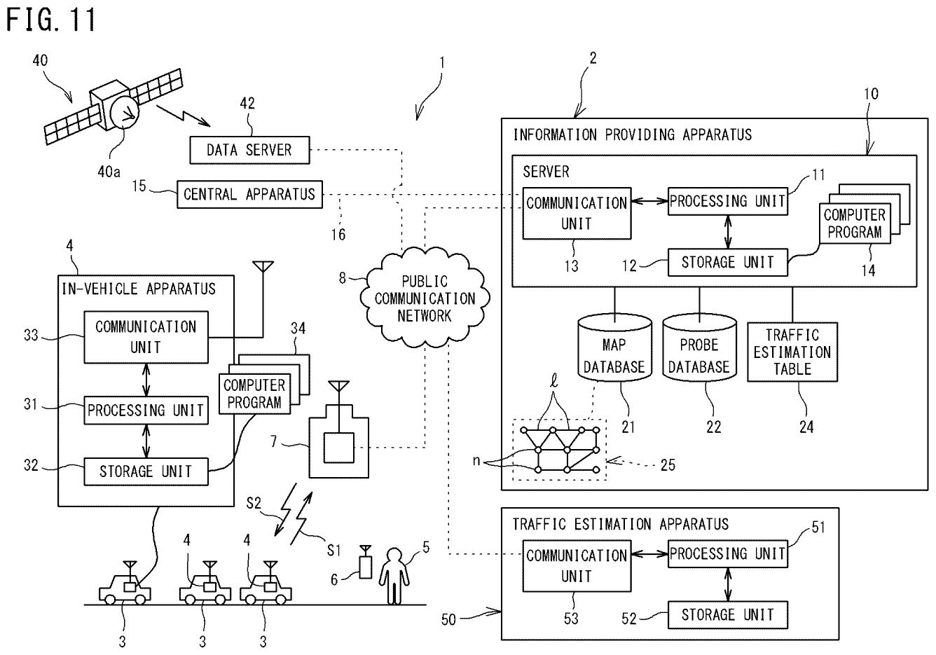

It is noted that, the embodiments disclosed herein are illustrative and non-restrictive in every respect. For example, in the above embodiment, the case where information providing apparatus 2 executes the traffic estimation process and the update process has been illustrated. However, as shown in FIG. 11, the traffic estimation process and the update process may be executed by a traffic estimation apparatus 50 connected to public communication network 8. Information providing system 1 shown in FIG. 11 is the same as information providing system 1 of the above embodiment except that traffic estimation apparatus 50 is connected to public communication network 8. In FIG. 11, traffic estimation apparatus 50 includes a processing unit 51, a storage unit 52, and a communication unit 53. Processing unit 51, storage unit 52, and communication unit 53 have the same configurations as processing unit 11, storage unit 12, and communication unit 13 of server 10.

Processing unit 51 performs a process of acquiring necessary information such as probe information from information providing apparatus 2 and information on traffic estimation table 24 via communication unit 53. Further, processing unit 51 has a function of executing a traffic estimation process and an update process using the acquired information. Thus, traffic estimation apparatus 50 can perform the traffic estimation process and the update process instead of information providing apparatus 2.

Processing unit 51 provides the estimate of the traffic obtained by the traffic estimation process to information providing apparatus 2. Further, processing unit 51 updates traffic estimation table 24 included in information providing apparatus 2 by the update process. In this case, traffic estimation apparatus 50 can execute the traffic estimation process and the update process even when traffic estimation apparatus 50 does not include probe database 22 or traffic estimation table 24.

Further, although FIG. 11 illustrates the case where traffic estimation apparatus 50 is connected to public communication network 8, traffic estimation apparatus 50 and information providing apparatus 2 may be connected to each other via a LAN, a leased line, or the like as long as traffic estimation apparatus 50 and information providing apparatus 2 are connected to each other so as to be capable of communicating with each other.

Further, in the above-described embodiment, the case where the traffic estimation process and the update process are executed mainly using the captured image among the satellite data has been illustrated. However, instead of captured image, it may be configured to execute the traffic estimation process and update process using complex data or similar data.

The scope of the present invention is defined by the appended claims rather than the above description, and is intended to include all modifications within the scope and meaning equivalent to the appended claims.

### REFERENCE SIGNS LIST

1 information providing system
2 information providing apparatus
3 probe vehicle
4 in-vehicle apparatus
5 user
6 user terminal
7 wireless base station
8 public communication network
10 server
11 processing unit
11a traffic estimation process
11b update process
12 storage unit
13 communication unit
14 computer program
15 central apparatus
16 leased line
21 map database
22 probe database
24 traffic estimation table
25 road map data
30 vehicle
31 processing unit
32 storage unit
33 communication unit
34 computer program
40 artificial satellite
40a antenna
42 data server
50 traffic estimation apparatus
51 processing unit
52 storage unit
53 communication unit
A area
F field
J1 intersection
J2 intersection
L distance
1 directed link
P1, P11 first target point
P2 second target point
R1, R11 inflow road
R2 inflow road
S target section
S1 uplink information
S2 downlink information
U sag portion
tp, tp1, tp11, tp2, tp3 trajectory point

1. A traffic estimation apparatus comprising:
a communication unit configured to communicate with a plurality of probe vehicles;
a storage unit configured to store probe information of the plurality of probe vehicles; and
a processing unit configured to execute a traffic estimation process for obtaining an estimate of vehicle traffic on an inflow road connected to a first target point on a road network, wherein
the traffic estimation process includes
a first process for obtaining movement information based on the probe information, the movement information including a time taken for a probe vehicle located at a second target point on the inflow road to pass through the first target point and a distance from the second target point to the first target point, and
a second process for obtaining the estimate with reference to a traffic estimation table, the traffic estimation table being updated based on satellite data obtained by observing an area including the first target point and the inflow road,
the traffic estimation table has registered therein vehicle count information indicating the number of vehicles from a position of a probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other, and
the second process obtains the estimate based on the vehicle count information corresponding to the movement information obtained in the first process.

2. The traffic estimation apparatus according to claim 1, wherein
the inflow road includes a target section, and
the second target point is at least one of a plurality of trajectory points in the target section, the plurality of trajectory points being included in the probe information of a probe vehicle having entered the inflow road.

3. The traffic estimation apparatus according to claim 2, wherein
the second target point is a trajectory point farthest from the first target point among the plurality of trajectory points.

4. The traffic estimation apparatus according to claim 1, wherein
the second target point is each of a plurality of trajectory points in a target section on the inflow road, the plurality of trajectory points being included in the probe information of a probe vehicle having entered the inflow road.

5. The traffic estimation apparatus according to claim 1, wherein
when the traffic estimation table does not have registered therein the vehicle count information corresponding to the movement information obtained in the first process, the second process obtains the estimate with reference to an other traffic estimation table determined in advance,
the other traffic estimation table being a table for obtaining an estimate of vehicle traffic on an other inflow road different from the inflow road, and being different from the traffic estimation table.

6. The traffic estimation apparatus according to claim 1, wherein
the first target point includes a point, a node, and a sag portion in a link included in the road network.

7. The traffic estimation apparatus according to claim 1, wherein
the estimate includes the number of vehicles indicated by the vehicle count information, and a vehicle density from the second target point to the first target point.

8. The traffic estimation apparatus according to claim 1, wherein
the communication unit is capable of communicating with a providing device for the satellite data, and
the processing unit is configured to execute an update process for updating the traffic estimation table based on the satellite data acquired from the providing device.

9. The traffic estimation apparatus according to claim 8, wherein
the update process includes
a process for acquiring the satellite data from the providing device,
a determination process for determining, based on the probe information, whether the probe vehicle is present on the inflow road at the time of observation, and
a process for determining whether to use the acquired satellite data to update the traffic estimation table, in accordance with a result of the determination process.

10. A traffic estimation apparatus comprising:
a communication unit; and
a processing unit configured to execute a traffic estimation process for obtaining an estimate of vehicle traffic on an inflow road connected to a first target point on a road network, wherein
the traffic estimation process includes
a process for acquiring probe information of a plurality of probe vehicles via the communication unit,
a first process for obtaining movement information based on the probe information, the movement information including a time taken for a probe vehicle located at a second target point on the inflow road to pass through the first target point and a distance from the second target point to the first target point, and
a second process for obtaining the estimate with reference to a traffic estimation table, the traffic estimation table being updated based on satellite data obtained by observing an area including the first target point and the inflow road,
the traffic estimation table has registered therein vehicle count information indicating the number of vehicles from a position of a probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other, and
the second process obtains the estimate based on the vehicle count information corresponding to the movement information obtained in the first process.

11. An update apparatus comprising:
a communication unit configured to communicate with a providing device for satellite data and communicate with a probe vehicle, the satellite data being obtained by observing an area including a first target point on a road network and an inflow road to the first target point;
a storage unit configured to store probe information of the probe vehicle; and
a processing unit configured to execute an update process for updating a traffic estimation table based on the satellite data, wherein
the update process includes
a process for acquiring the satellite data from the providing device, a process for counting the number of vehicles from a position of the probe vehicle present on the inflow road at a time of observation to the first target point, based on the satellite data,
a process for obtaining movement information based on the probe information, the movement information including a time taken for the probe vehicle present on the inflow road at the time of observation to pass through the first target point from the position and a distance from the position to the first target point, and
a process for registering, in the traffic estimation table, vehicle count information indicating the number of vehicles and the movement information in association with each other or updating the traffic estimation table.

12. The update apparatus according to claim 11, wherein
the update process further includes
a determination process for determining, based on the probe information, whether at least one of a plurality of the probe vehicle and at least another probe vehicle is present on the inflow road at the time of observation.

13. An update apparatus comprising:
a communication unit; and
a processing unit configured to execute an update process for updating a traffic estimation table based on satellite data, the satellite data being obtained by observing an area including a first target point on a road network and an inflow road to the first target point, wherein
the update process includes
a process for acquiring the satellite data and probe information of a probe vehicle via the communication unit,
a process for counting the number of vehicles from a position of the probe vehicle present on the inflow road at a time of observation to the first target point, based on the satellite data,
a process for obtaining movement information based on the probe information, the movement information including a time taken for the probe vehicle present on the inflow road at the time of observation to pass through the first target point from the position and a distance from the position to the first target point, and
a process for registering, in the traffic estimation table, vehicle count information indicating the number of vehicles and the movement information in association with each other or updating the traffic estimation table.

14. A traffic estimation method for obtaining an estimate of vehicle traffic on an inflow road connected to a first target point on a road network, the traffic estimation method comprising:
obtaining movement information based on probe information, the movement information including a time taken for a probe vehicle located at a second target point on the inflow road to pass through the first target point and a distance from the second target point to the first target point; and
obtaining the estimate with reference to a traffic estimation table, the traffic estimation table being updated based on satellite data obtained by observing an area including the first target point and the inflow road, wherein
the traffic estimation table has registered therein vehicle count information indicating the number of vehicles from a position of the probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other, and
the obtaining the estimate obtains the estimate based on the vehicle count information corresponding to the movement information obtained in the obtaining movement information.

15. A non-transitory computer readable storage medium storing a computer program for causing a computer to execute a traffic estimation process for obtaining an estimate of vehicle traffic on an inflow road connected to a first target point on a road network,
the computer program causing the computer to execute:
obtaining movement information based on probe information, the movement information including a time taken for a probe vehicle located at a second target point on the inflow road to pass through the first target point and a distance from the second target point to the first target point; and
obtaining the estimate with reference to a traffic estimation table, the traffic estimation table being updated based on satellite data obtained by observing an area including the first target point and the inflow road, wherein
the traffic estimation table has registered therein vehicle count information indicating the number of vehicles from a position of the probe vehicle present on the inflow road at a time of observation to the first target point, and the movement information of the probe vehicle present on the inflow road at the time of observation, the number of vehicles being counted based on the satellite data, the movement information of the probe vehicle being obtained based on the probe information, the vehicle count information and the movement information of the probe vehicle being registered in association with each other, and
the obtaining the estimate obtains the estimate based on the vehicle count information corresponding to the movement information obtained in the obtaining movement information.

16. An update method for updating a traffic estimation table, the update method comprising:
acquiring satellite data obtained by observing an area including a first target point on a road network and an inflow road to the first target point;
counting the number of vehicles from a position of a probe vehicle present on the inflow road at a time of observation to the first target point, based on the satellite data;
obtaining movement information based on probe information of the probe vehicle, the movement information including a time taken for the probe vehicle present on the inflow road at the time of observation to pass through the first target point from the position and a distance from the position to the first target point; and
registering, in the traffic estimation table, vehicle count information indicating the number of vehicles and the movement information in association with each other or updating the traffic estimation table.

17. A non-transitory computer readable storage medium storing a computer program for causing a computer to execute an update process for updating a traffic estimation table,
the computer program causing the computer to execute:
acquiring satellite data obtained by observing an area including a first target point on a road network and an inflow road to the first target point;
counting the number of vehicles from a position of the probe vehicle present on the inflow road at a time of observation to the first target point, based on the satellite data;
obtaining movement information based on probe information of the probe vehicle, the movement information including a time taken for the probe vehicle present on the inflow road at the time of observation to pass through the first target point from the position and a distance from the position to the first target point; and
registering, in the traffic estimation table, vehicle count information indicating the number of vehicles and the movement information in association with each other or updating the traffic estimation table.
